(19) United States
(12) Patent Application Publication
(10) Pub. No.: US 2016/0328241 A1
(43) Pub. Date: Nov. 10, 2016

(54) Data processing method for multiple operating systems and terminal equipment

(71) Applicant: ZTE CORPORATION, Shenzhen, Guangdong (CN)

(72) Inventors: Jingshan Song, Shenzhen (CN); Ping Xiong, Shenzhen (CN)

(21) Appl. No.: 15/109,585

(22) PCT Filed: May 29, 2014
(86) PCT No.: PCT/CN2014/078759

§ 371 Date: Jul. 1, 2016

(30) Foreign Application Priority Data
Jan. 3, 2014 (CN) 201410003922.8

(51) Int. Cl. G06F 9/44

(52) U.S. Cl. CPC G06F 9/441; G06F 9/4403

(57) ABSTRACT

A data processing method for multiple operating systems and a terminal equipment are described. The terminal equipment has a display area and is capable of running multiple operating systems simultaneously by means of split-screen displaying. The method includes that: after a user operation is triggered, responding to the user operation and receiving a control instruction, and performing data processing based on multiple concurrently running operating systems according to the control instruction.

### TECHNICAL FIELD

The present disclosure relates to the data processing technology of mobile communications, and more particularly, to a data processing method for multiple operating systems (multi-OS) and a terminal equipment.

### BACKGROUND

The inventor of this application finds at least following technical problems existing in the related art during implementing technical schemes of embodiments of this application:

with the popularity of smart phones, more and more companies begin to march in the market of smart phones and launch their own operating systems, thus various mobile phone operating systems are available on the market; among these mobile phone operating systems, the Android operating system of Google and the Windows system of Microsoft are most representative. The appearance of these mobile phone operating systems not only provides more choices for the integration process of an Original Equipment Manufacturer (OEM), but also provides more choices for a user to purchase a mobile phone. As the appearance of big-screen design modes of smart phones, a single mobile phone screen can display two interfaces simultaneously, however, only interfaces corresponding to two applications controlled by one same operating system can be displayed; the mobile phone cannot be controlled using multiple different operating systems simultaneously; for this problem, there is no effective solution in the related art.

### SUMMARY

In view of this, embodiments of the present disclosure are intended to provide a data processing method for multiple operating systems and a terminal equipment, which can use multiple different operating systems simultaneously to control the terminal equipment. Preferably,

A data processing method for multiple operating systems is provided, which is applied to a terminal equipment, wherein the terminal equipment has a display area, and is capable of running multiple operating systems simultaneously by means of split-screen displaying; the method includes:

after a user operation is triggered, responding to the user operation and receiving a control instruction, and performing data processing based on multiple concurrently running operating systems according to the control instruction.

Preferably, when the control instruction is an instruction to start up the multiple operating systems, the step of performing data processing based on multiple concurrently running operating systems according to the control instruction may specifically include:

starting up a first operating system, displaying the first operating system and applications running on the first operating system in a first split screen of the display area;

after the first operating system is started up, starting up an Nth operating system running environment, where N is a natural number greater than 1;

starting up an Nth operating system in the Nth operating system running environment, displaying the Nth operating system and applications running on the Nth operating system in an Nth split screen of the display area.

Preferably, when the control instruction is an instruction to shut down the multiple operating systems, the step of performing data processing based on multiple concurrently running operating systems according to the control instruction may specifically include:

shutting down an Nth operating system and applications running on the Nth operating system displayed in an Nth split screen of the display area, where N is a natural number greater than 1;

shutting down an Nth operating system running environment;

shutting down a first operating system and applications running on the first operating system displayed in a first split screen of the display area.

Preferably, when the control instruction is an instruction to display the multiple operating systems, the step of performing data processing based on multiple concurrently running operating systems according to the control instruction may specifically include:

judging, by a first operating system, whether the instruction to display the multiple operating systems is issued by an application running on an Nth operating system or by an application running on a first operation system, where N is a natural number greater than 1;

if the instruction to display the multiple operating systems is issued by the application running on the first operating system, calculating, by the first operating system, to refresh an interface scope of a first split-screen and calling a display service driver to display;

if the instruction to display the multiple operating systems is issued by the application running on the Nth operating system, calculating, by the first operating system, to refresh an interface scope of an Nth split-screen and calling a display service driver to display.

Preferably, when the control instruction is a multi-operating system receiving instruction, the step of performing data processing based on multiple concurrently running operating systems according to the control instruction may specifically include:

receiving, by a first operating system, the multi-operating system receiving instruction, and judging, by the first operating system, whether the multi-operating system receiving instruction is input from a first split screen or from an Nth split screen, where N is a natural number greater than 1;

if the multi-operating system receiving instruction is input from the first split screen, sending the input instruction to an application running on the first operating system;

if the multi-operating system receiving instruction is input from the Nth split screen, sending the input instruction to an Nth operating system, which then sends to an application running thereon.

A terminal equipment is provided, which has a display area and is capable of running multiple operating systems simultaneously by means of split-screen displaying, wherein the terminal equipment further includes:

a data processing device, which is configured to: after a user operation is triggered, respond to the user operation and receive a control instruction, and perform data processing based on multiple concurrently running operating systems according to the control instruction.

Preferably, wherein the data processing device may include:

a first operating system, which is configured to: when the control instruction is an instruction to start up the multiple operating systems, start up in response to the instruction to start up the multiple operating systems;

an Nth operating system running environment, which is configured to acquire required running resources from the first operating system and to provide an running environment for an Nth operating system, where N is a natural number greater than 1;

the Nth operating system, which is configured to start up in the Nth operating system running environment;

a display screen, which is configured to: after the first operating system is started up, display the first operating system and applications running on the first operating system in a first split screen of the display area; after the Nth operating system is started up in the Nth operating system running environment, display the Nth operating system and applications running on the Nth operating system in an Nth split screen of the display area.

Preferably, the data processing device may include:

a first operating system, which is configured to: when the control instruction is an instruction to shut down the multiple operating systems, shut down in response to the instruction to shut down the multiple operating systems;

an Nth operating system, which is configured to shut down in an Nth operating system running environment, where N is a natural number greater than 1;

the Nth operating system running environment, which is configured to shut down after the Nth operating system is shut down;

the display area, which is configured to shut down the Nth operating system and applications running on the Nth operating system displayed in an Nth split screen of the display area, and is configured to shut down the first operating system and applications running on the first operating system displayed in a first split screen of the display area.

Preferably, the data processing device may include:

a first operating system, which is configured to: when the control instruction is an instruction to display the multiple operating systems, respond to the instruction to display the multiple operating systems, wherein if the instruction to display the multiple operating systems is issued by an application running on the first operating system, the first operating system calculates to refresh an interface scope of a first split-screen and calls a display service driver to display; if the instruction to display the multiple operating systems is issued by an application running on an Nth operating system, the first operating system calculates to refresh an interface scope of an Nth split-screen and calls a display service driver to display, where N is a natural number greater than 1;

the display service driver, which is configured to run on the first operating system to control a display screen;

an Nth operating system running environment, which is configured to acquire required running resources from the first operating system and to provide an running environment for the Nth operating system;

the Nth operating system, which is configured to run in the Nth operating system running environment;

the display screen, which is configured to: when the first operating system calculates to refresh the interface scope of the first split-screen and calls the display service driver to display, be controlled by the display service driver to refresh the interface of the first split screen, the refreshed first split-screen displaying the first operating system and applications running on the first operating system; when the first operating system calculates to refresh the interface scope of the Nth split-screen and calls the display service driver to display, be controlled by the display service driver to refresh the interface of the Nth split screen, the refreshed Nth split-screen displaying the Nth operating system and applications running on the Nth operating system.

Preferably, the data processing device may include:

a first operating system, which is configured to: when the control instruction is a multi-operating system receiving instruction, respond to the multi-operating system receiving instruction; if the multi-operating system receiving instruction is input from a first split screen, send the multi-operating system receiving instruction to an application running on the first operating system; if the multi-operating system receiving instruction is input from an Nth split screen, send the multi-operating system receiving instruction to an Nth operating system, which then forwards to an application running thereon, where N is a natural number greater than 1;

an Nth operating system running environment, which is configured to acquire required running resources from the first operating system and to provide an running environment for the Nth operating system,

the Nth operating system, which is configured to run in the Nth operating system running environment;

a display screen, which is configured to: display the first operating system and applications running on the first operating system in the first split screen of the display area, wherein if the multi-operating system receiving instruction is input from the first split screen, the application running on the first operating system responds to the multi-operating system receiving instruction sent by the first operating system; and display the Nth operating system and applications running on the Nth operating system in the Nth split screen of the display area, wherein if the multi-operating system receiving instruction is input from the Nth split screen, the application running on the Nth operating system responds to the multi-operating system receiving instruction forwarded by the Nth operating system.

The method of the embodiment of the present disclosure is applied to a terminal equipment, wherein the terminal equipment has a display area and is capable of running multiple operating systems simultaneously by means of split-screen displaying. The method comprises: after a user operation is triggered, responding to the user operation and receiving a control instruction, and performing data processing based on multiple concurrently running operating systems according to the control instruction. With the embodiment of the present disclosure, since multiple operating systems are running simultaneously by means of split-screen displaying, a control instruction is received and data processing is performed based on multiple concurrently running operating systems according to the control instruction, multiple different operating system can be used simultaneously to control the terminal equipment.

### BRIEF DESCRIPTION OF THE DRAWINGS

FIG. 1 is a structure diagram of a device running dual operating systems according to an embodiment of the present disclosure;

FIG. 2 is a flow chart of a method for starting up dual operating systems according to an embodiment of the present disclosure;

FIG. 3 is a flow chart of a method for shutting down dual operating systems according to an embodiment of the present disclosure;

FIG. 4 is a flow chart of a method for displaying output of dual operating systems according to an embodiment of the present disclosure; and

FIG. 5 is a flow chart of an input method of dual operating systems according to an embodiment of the present disclosure.

### DETAILED DESCRIPTION

The implementation of the technical scheme is described below in further detail in combination with the accompanying drawings.

Embodiments of the present disclosure refer to solutions for running multiple operating systems simultaneously by means of split-screen displaying. An embodiment of the present disclosure provides a data processing method for multiple operating systems, which is applied to a terminal equipment, wherein the terminal equipment has a display area, and is capable of running multiple operating systems simultaneously by means of split-screen displaying; the method comprises: after a user operation is triggered, responding to the user operation and receiving a control instruction, and performing data processing based on multiple concurrently running operating systems according to the control instruction.

An embodiment of the present disclosure provides a terminal equipment, which has a display area and is capable of running multiple operating systems simultaneously by means of split-screen displaying, wherein the terminal equipment further includes: a data processing device, which is configured to: after a user operation is triggered, respond to the user operation and receive a control instruction, and perform data processing based on multiple concurrently running operating systems according to the control instruction

Taking the terminal equipment being a smart phone for example, present smart phones can implement split-screen displaying; although it is implemented that a single screen can display two interfaces simultaneously, the screen can display only the interfaces corresponding to two applications controlled by one same operating system and cannot be controlled using two operating systems simultaneously. This does not play the function of multi-screen thoroughly in the condition of two split-screens. If multiple operating systems can be running simultaneously by means of split-screen displaying in one smart phone, for example, two operating systems, one is an Android operating system and the other is a Windows operating system, during split-screen displaying half-screen runs the Android system more suitable for entertainments while the other half-screen runs the windows operating system more suitable for working, the advantages of split-screen will be thoroughly played.

The embodiment of the present disclosure is illustrated below by taking dual operating systems being displayed in a split-screen manner for example.

1. Starting up dual operating systems using the embodiment of the present disclosure includes the following steps:

(1) A mobile terminal receives a startup instruction.

(2) The first operating system starts up normally, the same as a common single-operation system terminal.

(3) After the first operating system finishes startup, starting up the second operating system running environment.

(4) After the second operating system running environment finishes startup, starting up the second operating system in the second operating system running environment.

(5) Dual operating systems start up completed.

Here it should be noted that the emphasis of the embodiment of the present disclosure lies in starting up the second operating system running environment first and then starting the second operating system in the second operating system running environment.

2. Shutting down dual operating systems using the embodiment of the present disclosure includes the following steps:

(1) A mobile terminal receives a shutdown instruction.

(2) Shutting down the second operating system running in the second operating system running environment and applications running on the second operating system.

(3) Shutting down the second operating system running environment.

(4) Shutting down the first operating system and applications running on the first operating system.

(5) Shutdown completed.

Here it should be noted that the emphasis of the embodiment of the present disclosure lies in shutting down the second operating system in the second operating system running environment and then shutting down the second operating system running environment.

3. Displaying interfaces of dual operating systems using the embodiment of the present disclosure includes the following steps:

(1) The first operating system receives a display instruction.

(2) The first operating system judges whether the display instruction is issued by the application running on the second operating system or by the application running on the first operating system.

(3) If the display instruction is issued by the application running on the first operating system, the first operating system calculates to refresh the interface scope of the first split-screen and calls a display service driver to display. The display service driver controls the first split screen to refresh interface.

(4) If the display instruction is issued by the application running on the second operating system, the first operating system calculates to refresh the interface scope of the second split-screen and calls a display service driver to display. The display service driver controls the second split screen to refresh interface.

Here it should be noted that the emphasis of the embodiment of the present disclosure lies in that both executing subjects are the first operating system, that is, the first operating system receives the instruction and performs various judgements.

4. Dual operating systems receiving touch screen inputs using the embodiment of the present disclosure includes the following steps:

(1) The first operating system receives a touch input instruction.

(2) The first operating system judges whether the input instruction is input from the first split screen or from the second split screen.

(3) If the instruction is input from the first split screen, sending the instruction to the application running on the first operating system.

(4) If the instruction is input from the second split screen, sending the instruction to the second operating system, which then sends to the application running thereon.

In the embodiment of the present disclosure, the first operating system is an original operating system, or can be called a master operating system; the first operating system can start up hardware, while the second operating system cannot start up hardware; the second operating system also can be called a slave operating system, which needs to call hardware via the first operating system before implementing a series of functions. Compared with the related art, the embodiment of the present disclosure can provide a scheme for a mobile terminal to run dual operating systems, which runs dual operating systems in a split-screen displaying terminal, making the advantages of split-screen thoroughly played.

The core part of the data processing device in the terminal equipment provided by the embodiment of the present disclosure includes:

(1) the first operating system, which realizes Central Processing Unit (CPU) management, storage management, equipment management and other functions; in the dual operating systems of the embodiment of the present disclosure, it is the first operating system that truly performs management of equipment hardware;

(2) the second operating system running environment, of which the required running resources are provided by the first operating system and which provides a running environment to the second operating system;

(3) the second operating system, which is the second operating system of the dual operating systems in the embodiment of the present disclosure and runs in the second operating system running environment;

(4) the display screen, which might be a touch display screen for a touch display terminal, in particular, a touch/display screen with a split-screen function, which is divided into a first split screen and a second split screen, wherein the first split screen displays the interface of the first operating system and applications running on the first operating system and accepts inputs on the first split screen by a user, the second split screen displays the interface of the second operating system and applications running on the second operating system and accepts inputs on the second split screen by a user;

(5) the display service driver, which runs on the first operating system to control the touch/display screen (the display screen might be a touch display screen for a touch display terminal).

The embodiment of the present disclosure is illustrated below in detail depending on application scenarios.

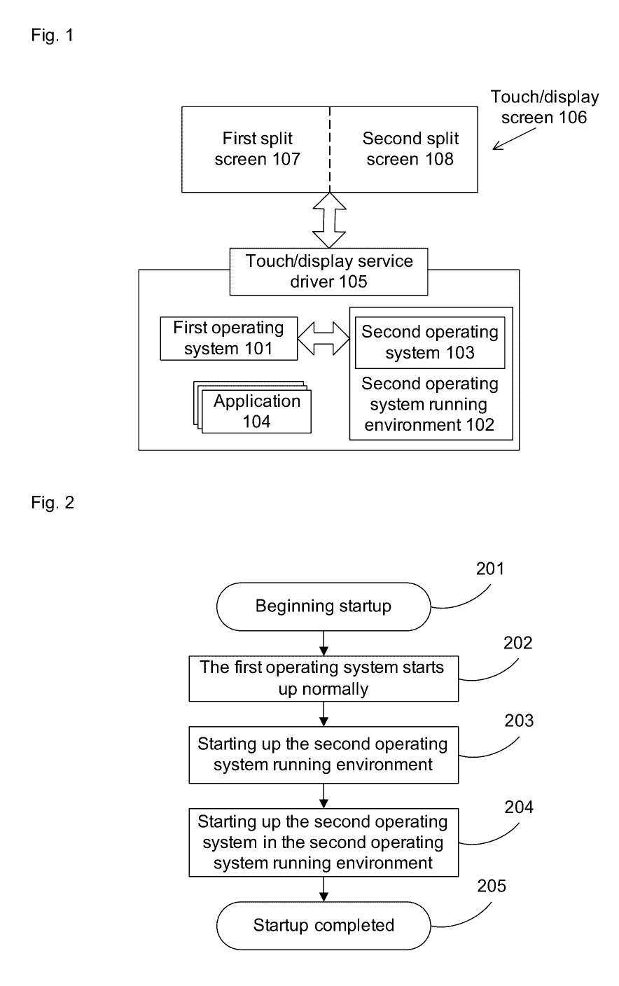

FIG. 1 shows a data processing device running dual operating systems in a mobile terminal, which includes the following components:

a first operating system 101, which realizes CPU management, storage management, equipment management and other functions; in the dual operating systems, it is the first operating system that truly performs management of equipment hardware;

a second operating system running environment 102, of which the required running resources are provided by the first operating system and which provides a running environment to the second operating system;

a second operating system 103, which is the second operating system of the dual operating systems and runs in the second operating system running environment, including an operating system and applications, services, drivers and the like running thereon;

an application 104 running on the first operating system, including applications, services, drivers and the like;

a touch/display service driver 105, which runs on the first operating system to control the touch/display screen;

a touch/display screen 106, which has a split-screen function and consists of a first split screen 107 and a second split screen 108;

the first split screen 107, which is a part of the touch/display screen and is configured to display the interface of the first operating system and applications running on the first operating system and accept inputs on the first split screen by a user;

the first split screen 108, which is a part of the touch/display screen and is configured to display the interface of the second operating system and applications running on the second operating system and accept inputs on the second split screen by a user.

Application scenario 1: based on the device shown in FIG. 1, in the method for running dual operating systems in a mobile terminal according to the embodiment of the present disclosure, the startup process, as show in FIG. 2, includes that:

S201: A mobile terminal receives a startup instruction (or called booting instruction)

S202: The first operating system starts up normally, the same as a common single-operation system terminal.

S203: After the first operating system finishes startup, starting up the second operating system running environment.

S204: After the second operating system running environment finishes startup, starting up the second operating system.

S205: Dual operating systems startup (or called booting) completed.

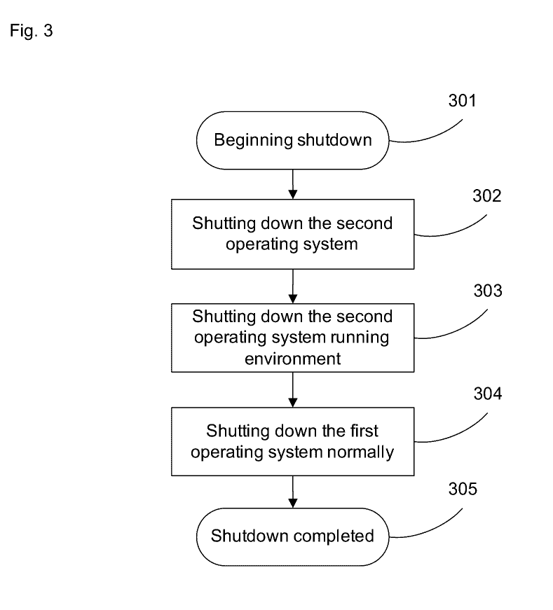

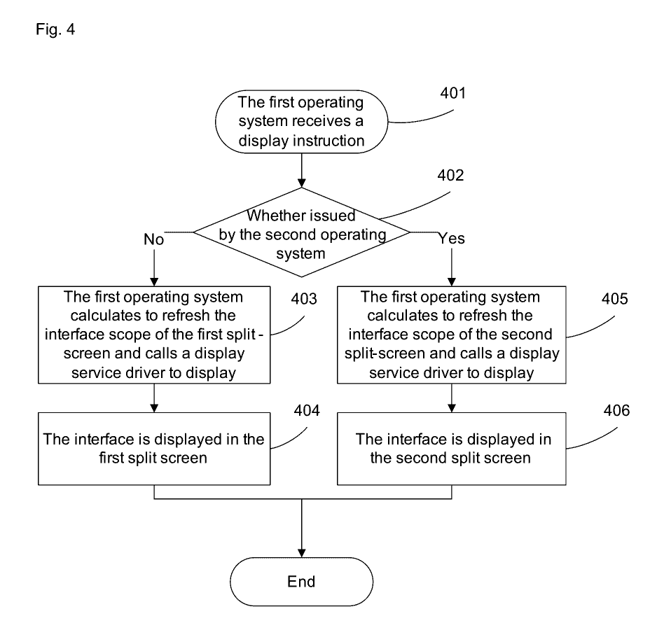

Application scenario 2: based on the device shown in FIG. 1, in the method for running dual operating systems in a mobile terminal according to the embodiment of the present disclosure, the shutdown process, as show in FIG. 3, includes that:

S301: A mobile terminal receives a shutdown instruction (or called power off instruction).

S302: Shutting down the second operating system and applications running on the second operating system.

S303: Shutting down the second operating system running environment.

S304: Shutting down the first operating system and applications running on the first operating system.

S305: Shutdown (or called power off) completed.

Application scenario 3: based on the device shown in FIG. 1, in the method for running dual operating systems in a mobile terminal according to the embodiment of the present disclosure, the display process, as show in FIG. 3, includes that:

S401: The first operating system receives a display instruction.

S402: The first operating system judges whether the display instruction is issued by an application running on the second operating system or by an application running on the first operating system.

S403: If the display instruction is issued by the application running on the first operating system, the first operating system calculates to refresh the interface scope of the first split-screen and calls a display service driver to display.

S404: The display service driver controls the first split screen to refresh interface and the interface is displayed in the first split screen.

S405: If the display instruction is issued by the application running on the second operating system, the first operating system calculates to refresh the interface scope of the second split-screen and calls a display service driver to display.

S406: The display service driver controls the second split screen to refresh interface and the interface is displayed in the second split screen.

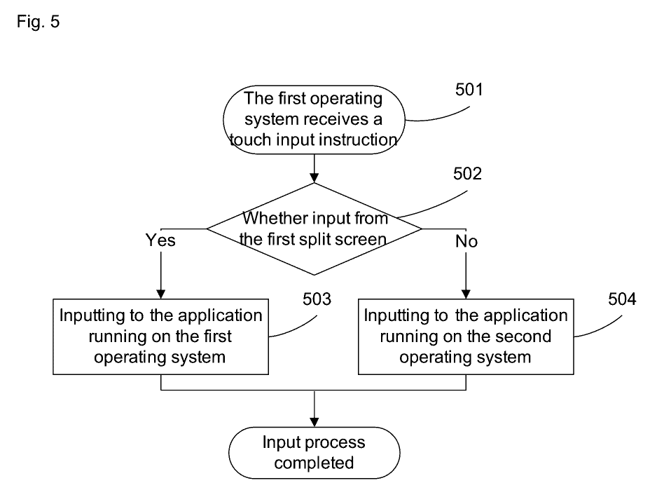

Application scenario 4: based on the device shown in FIG. 1, in the method for running dual operating systems in a mobile terminal according to the embodiment of the present disclosure, the input process, as show in FIG. 5, includes:

S501: The first operating system receives a touch input instruction.

S502: The first operating system judges whether the input instruction is input from the first split screen or from the second split screen.

S503: If the instruction is input from the first split screen, sending the instruction to the application running on the first operating system.

S504: If the instruction is input from the second split screen, sending the instruction to the second operating system, which then sends to the application running thereon.

If the integrated modules involved in the embodiment of the present disclosure are realized in the form of software function modules and are sold or used as an independent product, they can be stored in computer readable storage medium. Based on this understanding, the technical scheme of the embodiment of the present disclosure or the part making a contribution to the existing technology on essence can be embodied in the form of software product. This computer software product is stored in a storage medium, including a number of instructions that enables a computer device (which might be a computer, a server or a network device, etc.) to execute all or part of the method described in each embodiment of the present disclosure. The aforementioned storage medium includes: USB flash disk, mobile hard disk, Read-Only Memory (ROM), Random Access Memory (RAM), diskette or compact disc and various mediums that can store program codes. In this way, the embodiment of the present disclosure is not limited to any specific combination of hardware and software.

Correspondingly, the embodiment of the present disclosure further provides a computer storage medium storing a computer program that is configured to execute the data processing method for multiple operating systems in the embodiment of the present disclosure.

To sum up, the above are the preferred embodiments of the present disclosure only and not intended to limit the protection scope of the present disclosure.

### INDUSTRIAL APPLICABILITY

The method of the embodiment of the present disclosure is applied to a terminal equipment, wherein the terminal equipment has a display area and is capable of running multiple operating systems simultaneously by means of split-screen displaying. The method comprises: after a user operation is triggered, responding to the user operation and receiving a control instruction, and performing data processing based on multiple concurrently running operating systems according to the control instruction. With the embodiment of the present disclosure, since multiple operating systems are running simultaneously by means of split-screen displaying, a control instruction is received and data processing is performed based on multiple concurrently running operating systems according to the control instruction, multiple different operating system can be used simultaneously to control the terminal equipment.

What is claimed is:

1. A data processing method for multiple operating systems, which is applied to a terminal equipment, wherein the terminal equipment has a display area and is capable of running multiple operating systems simultaneously by means of split-screen displaying; the method comprising:
after a user operation is triggered, responding to the user operation and receiving a control instruction, and performing data processing based on multiple concurrently running operating systems according to the control instruction.

2. The method according to claim 1, wherein when the control instruction is an instruction to start up the multiple operating systems, the step of performing data processing based on multiple concurrently running operating systems according to the control instruction specifically comprises:
starting up a first operating system, displaying the first operating system and applications running on the first operating system in a first split screen of the display area;
after the first operating system is started up, starting up an Nth operating system running environment, where N is a natural number greater than 1;
starting up an Nth operating system in the Nth operating system running environment, displaying the Nth operating system and applications running on the Nth operating system in an Nth split screen of the display area.

3. The method according to claim 1, wherein when the control instruction is an instruction to shut down the multiple operating systems, the step of performing data processing based on multiple concurrently running operating systems according to the control instruction specifically comprises:
shutting down an Nth operating system and applications running on the Nth operating system displayed in an Nth split screen of the display area, where N is a natural number greater than 1;
shutting down an Nth operating system running environment;
shutting down a first operating system and applications running on the first operating system displayed in a first split screen of the display area.

4. The method according to claim 1, wherein when the control instruction is an instruction to display the multiple operating systems, the step of performing data processing based on multiple concurrently running operating systems according to the control instruction specifically comprises:
judging, by a first operating system, whether the instruction to display the multiple operating systems is issued by an application running on an Nth operating system or by an application running on a first operation system, where N is a natural number greater than 1;
if the instruction to display the multiple operating systems is issued by the application running on the first operating system, calculating, by the first operating system, to refresh an interface scope of a first split-screen and calling a display service driver to display;
if the instruction to display the multiple operating systems is issued by the application running on the Nth operating system, calculating, by the first operating system, to refresh an interface scope of an Nth split-screen and calling a display service driver to display.

5. The method according to claim 1, wherein when the control instruction is a multi-operating system receiving instruction, the step of performing data processing based on multiple concurrently running operating systems according to the control instruction specifically comprises:
receiving, by a first operating system, the multi-operating system receiving instruction, and judging, by the first operating system, whether the multi-operating system receiving instruction is input from a first split screen or from an Nth split screen, where N is a natural number greater than 1;
if the multi-operating system receiving instruction is input from the first split screen, sending the input instruction to an application running on the first operating system;
if the multi-operating system receiving instruction is input from the Nth split screen, sending the input instruction to an Nth operating system, which then sends to an application running thereon.

6. A terminal equipment, which has a display area and is capable of running multiple operating systems simultaneously by means of split-screen displaying, wherein the terminal equipment further comprises:
a data processing device, which is configured to: after a user operation is triggered, respond to the user operation and receive a control instruction, and perform data processing based on multiple concurrently running operating systems according to the control instruction.

7. The terminal equipment according to claim 6, wherein the data processing device comprises:
a first operating system, which is configured to: when the control instruction is an instruction to start up the multiple operating systems, start up in response to the instruction to start up the multiple operating systems;
an Nth operating system running environment, which is configured to acquire required running resources from the first operating system and to provide an running environment for an Nth operating system, where N is a natural number greater than 1;
the Nth operating system, which is configured to start up in the Nth operating system running environment;
a display screen, which is configured to: after the first operating system is started up, display the first operating system and applications running on the first operating system in a first split screen of the display area; after the Nth operating system is started up in the Nth operating system running environment, display the Nth operating system and applications running on the Nth operating system in an Nth split screen of the display area.

8. The terminal equipment according to claim 6, wherein the data processing device comprises:
a first operating system, which is configured to: when the control instruction is an instruction to shut down the multiple operating systems, shut down in response to the instruction to shut down the multiple operating systems;
an Nth operating system, which is configured to shut down in an Nth operating system running environment, where N is a natural number greater than 1;
the Nth operating system running environment, which is configured to shut down after the Nth operating system is shut down;
the display area, which is configured to shut down the Nth operating system and applications running on the Nth operating system displayed in an Nth split screen of the display area, and is configured to shut down the first operating system and applications running on the first operating system displayed in a first split screen of the display area.

9. The terminal equipment according to claim 6, wherein the data processing device comprises:
a first operating system, which is configured to: when the control instruction is an instruction to display the multiple operating systems, respond to the instruction to display the multiple operating systems, wherein if the instruction to display the multiple operating systems is issued by an application running on the first operating system, the first operating system calculates to refresh an interface scope of a first split-screen and calls a display service driver to display; if the instruction to display the multiple operating systems is issued by an application running on an Nth operating system, the first operating system calculates to refresh an interface scope of an Nth split-screen and calls a display service driver to display, where N is a natural number greater than 1;
the display service driver, which is configured to run on the first operating system to control a display screen;
an Nth operating system running environment, which is configured to acquire required running resources from the first operating system and to provide an running environment for the Nth operating system;
the Nth operating system, which is configured to run in the Nth operating system running environment;
the display screen, which is configured to: when the first operating system calculates to refresh the interface scope of the first split-screen and calls the display service driver to display, be controlled by the display service driver to refresh the interface of the first split screen, the refreshed first split-screen displaying the first operating system and applications running on the first operating system; when the first operating system calculates to refresh the interface scope of the Nth split-screen and calls the display service driver to display, be controlled by the display service driver to refresh the interface of the Nth split screen, the refreshed Nth split-screen displaying the Nth operating system and applications running on the Nth operating system.

10. The terminal equipment according to claim 6, wherein the data processing device comprises:
a first operating system, which is configured to: when the control instruction is a multi-operating system receiving instruction, respond to the multi-operating system receiving instruction; if the multi-operating system receiving instruction is input from a first split screen, send the multi-operating system receiving instruction to an application running on the first operating system; if the multi-operating system receiving instruction is input from an Nth split screen, send the multi-operating system receiving instruction to an Nth operating system, which then forwards to an application running thereon, where N is a natural number greater than 1;
an Nth operating system running environment, which is configured to acquire required running resources from the first operating system and to provide an running environment for the Nth operating system,
the Nth operating system, which is configured to run in the Nth operating system running environment;
a display screen, which is configured to: display the first operating system and applications running on the first operating system in the first split screen of the display area, wherein if the multi-operating system receiving instruction is input from the first split screen, the application running on the first operating system responds to the multi-operating system receiving instruction sent by the first operating system; and display the Nth operating system and applications running on the Nth operating system in the Nth split screen of the display area, wherein if the multi-operating system receiving instruction is input from the Nth split screen, the application running on the Nth operating system responds to the multi-operating system receiving instruction forwarded by the Nth operating system.
